(19) United States
(12) Patent Application Publication
(10) Pub. No.: US 2009/0255506 A1
(43) Pub. Date: Oct. 15, 2009

(54) Rotary internal combustion engine

(76) Inventor: S. Paul Walker, Arlington, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/082,889

(22) Filed: Apr. 14, 2008

(51) Int. Cl. F02B 53/08

(52) U.S. Cl. 123/212; 418/61.1; 74/63

(57) ABSTRACT

The present invention relates to a rotary internal combustion engine that extracts power from expansion gases supplied to a rotary power-extraction assembly, and related methods. The disclosed engines include a compressor assembly, a combustion assembly, and a rotary power-extraction assembly. The compressor assembly supplies a compressed charge to the combustion assembly. The combustion assembly initiates combustion and discharges expansion gases to the rotary power-extraction assembly. A rotary power-extraction assembly can be configured to include an annular chamber where expansion gases drive a power rotor.

### BACKGROUND OF THE INVENTION

The present invention relates generally to the field of heat engines, and more particularly to internal combustion (IC) engines.

Heat engines convert thermal energy into mechanical output. An internal combustion engine is a type of heat engine that employs internal combustion of a fuel. IC engines have become a ubiquitous part of modern society. Example applications of IC engines are well known, from planes, trains, and automobiles, to boats, generators, and motorcycles. As such, the economic impact of IC engines is truly staggering in scope.

Currently available IC engines come in a number of varieties. Well known examples of these varieties include: reciprocating piston gasoline engines, reciprocating piston diesel engines, Wankel rotary engines, jet engines, and gas turbines. These varieties are employed in a range of different applications, with some varieties being favored in certain applications. For example, reciprocating piston diesel engines tend to be engine of choice in heavy equipment, such as bull dozers, buses, dump trucks, and the like, while jet engines are often used in larger airplanes, and gas turbines often used in the generation of power.

The thermo-dynamic efficiency of currently available IC engines is less than ideal. The thermo-dynamic efficiency of a heat engine is measured by comparing the amount of mechanical output produced to the thermal energy of the fuel consumed. A typical reciprocating piston gasoline engine used in a modern automobile may only be about 20 to 25 percent efficient from a thermo-dynamic perspective. A typical diesel engine is only in the 30-40 percent efficiency range. Although modern jet engines may have efficiencies between 50-60 percent, the use of these engines is limited due to their high cost and relatively limited operating range. As a result of these low efficiencies, the majority of the thermal energy released during the combustion of the fuel is not converted into usable mechanical output, but is instead results in waste heat energy. Worldwide, this wasted heat energy amounts to a huge economic loss.

Reciprocating piston gasoline and diesel engines have less than ideal power extraction characteristics. The power extraction characteristics of reciprocating piston engines is hampered by their internal kinematics, which results in a varying moment arm between the force imparted on the connecting rod and the centerline of the crankshaft. At the start of the power stroke, when the piston is located at top dead center, the force line of the connecting rod passes through the centerline of the crank shaft, thereby precluding the generation of any usable output torque at this point in the cycle. Likewise, at the end of the power stroke, when the piston is located at bottom dead center, the force line once again passes through the centerline of the crank shaft. It is not until about the middle of the power stroke that the moment arm is maximized. In between the start and the end of the power stroke, the moment arm varies in conformance with the natural kinematics of these engines. The result of this varying moment arm is that for a significant portion of the power stroke, the forces generated by the expansion gases are not efficiently converted into usable mechanical energy.

Thermodynamic efficiency of reciprocating piston engines is primarily a function of compression ratio. A higher compression ratio is naturally more thermodynamically efficient because it results in a heat cycle with an increased difference between the temperature where the heat is added, and the temperature where waste heat is expelled. Reciprocating piston diesel engines have a significantly higher compression ratio than reciprocating piston gasoline engines, and accordingly are more thermodynamically efficient.

High compression reciprocating piston engines require slower burning fuel. Many luxury cars today require premium fuel, due to the increased compression ratio used in their engines. While this increased compression ratio results in higher power output due to the increased efficiency of the engine and the increased energy content of the premium fuel, premium fuel is more expensive than regular fuel. Diesel engines, with their even higher compression ratios, required even slower burning fuel. The use of the wrong fuel in an engine can result in engine damage. If a fuel is used that burns too fast, excessive pressures are generated too early in the power-stroke. Excessive pressures generated at the start of the power stroke result in high connecting rod forces. High connecting rod forces are reacted by the rod and crankshaft bearings, which may be damaged as a result.

Reciprocating piston engines have an operational speed range that is limited by how quickly the fuel burns. Diesel engines, with their slower burning fuel, typically have maximum rotations per minute significantly less than gasoline engines.

Operational characteristics, such as output torque versus engine speed, reliability, and cost, are important factors to consider when selecting the type of IC engine for a particular application. Although reciprocating piston gasoline engines are less efficient than reciprocating piston diesel engines, their greater operational speed range, power per weight, lower comparable noise level, and lower cost weigh heavily in favor of their use in typical automobiles. While diesel engines have a smaller operational speed range and are generally more expensive to produce, their increased torque, efficiency, and reliability weigh heavily in favor of their use in large scale applications, such as trucks, buses, ships, large generators, and the like. The relatively isolated use of Wankel rotary engines, despite their high power to weight ratio, can be attributed to their relatively low efficiency and poor reliability.

As such, there is a need for affordable and reliable IC engines with improved operational characteristics and efficiency.

### BRIEF SUMMARY OF THE INVENTION

The presently disclosed invention provides rotary IC engines (and related methods) with novel design features that may provide a number of benefits relative to existing IC engines. Rotary IC engines in accordance with the present invention may provide increased efficiency by more efficient extraction of mechanical power from the expansion gases produced during internal combustion. Rotary IC engines in accordance with the present invention may allow the use of higher levels of compression with any particular fuel. Rotary IC engines in accordance with the present invention may also provide a broad range of operational speeds, which would allow their use in a broad range of applications. Additionally, embodiments of the present invention may provide increased reliability due at least in part to the use of balanced power extraction.

Thus, in a first aspect, the present invention provides a rotary internal combustion engine that includes a compressor assembly, a combustion assembly, and a rotary power-extraction assembly. The combustion assembly is coupled with the compressor assembly so as to receive a compressed charge from the compressor assembly. The engine is adapted to provide isolation between the compressor assembly and the received compressed charge. The combustion assembly is adapted to initiate combustion after the isolation of the compressed charge and discharge expansion gases. The rotary power-extraction assembly is coupled with the combustion assembly so as to receive expansion gases discharged by the combustion assembly. The rotary power-extraction assembly is adapted to extract power from the received expansion gases.

Embodiments of the first aspect of the present invention can include a variety of different elements. The combustion assembly can include a rotating combustion chamber adapted to receive the compressed charge during a first rotation of the combustion chamber and provide isolation between the compressor assembly and the received compressed charge during a second rotation of the combustion chamber. The rotating combustion chamber can be mechanically coupled with the compressor assembly. The engine can be further adapted to provide isolation between the rotating combustion chamber and the rotating power-extraction assembly prior to combustion initiation. The engine can include a piston valve adapted to provide isolation between the rotating combustion chamber and the rotating power-extraction assembly prior to combustion initiation. The compressor assembly can include a crankshaft coupled with a reciprocating piston. The compressor assembly can include two or more crankshafts, with each crankshaft being coupled with at least one reciprocating piston. The compressor assembly can be mechanically coupled with the power-extraction assembly so as to transfer power from the rotary power-extraction assembly to the compressor assembly. The combustion assembly can include a combustion chamber. The engine can be further adapted to provide isolation between the combustion chamber and the rotating power-extraction assembly prior to combustion initiation.

In a second aspect, the present invention provides a rotary internal combustion engine that includes a compressor assembly, a combustion assembly, and a rotary power-extraction assembly that includes a housing, a power rotor, a sealing rotor, an inlet, and an outlet. The combustion assembly is coupled with the compressor assembly so as to receive a compressed charge from the compressor assembly. The combustion assembly is adapted to discharge expansion gases. The rotary power-extraction assembly is coupled with the combustion assembly so as to receive expansion gases discharged by the combustion assembly. The rotary power-extraction assembly is adapted to extract power from the received expansion gases. The housing includes a first cavity disposed within the housing and substantially defined by axial-symmetric walls, and a second cavity disposed within the housing and substantially defined by axial-symmetric walls, the second cavity intersecting the first cavity. The power rotor is rotationally disposed within the first cavity, with the power rotor and the housing defining an annular chamber therebetween, and the power rotor including a vane extending from the power rotor into the annular chamber. The sealing rotor is rotationally disposed within the second cavity, and includes a recess sized to accommodate the vane during a rotation of the power rotor. The inlet is coupled with the combustion assembly and the annular chamber for the transfer of expansion gases from the combustion assembly to the annular chamber. The outlet is coupled with the annular chamber for the discharge of expansion gases from the annular chamber.

Embodiments of the second aspect of the present invention can include a variety of different elements. The power rotor can further include a second vane extending from the power rotor into the annular chamber. The housing can further include a third cavity disposed within the housing and substantially defined by axial-symmetric walls, the third cavity intersecting the first cavity. The rotary power-extraction assembly can further include a second sealing rotor rotationally disposed within the third cavity, the second sealing rotor including a recess sized to accommodate the vanes during a rotation of the power rotor. The combustion assembly can be further adapted to initiate combustion. The engine can be adapted to provide isolation between the compressor assembly and expansion gases. The combustion assembly can include a rotating combustion chamber adapted to receive a compressed charge during a first rotation of the combustion chamber and to provide isolation between the compressor assembly and the received compressed charge during a second rotation of the combustion chamber. The engine can be further adapted to provide isolation between the rotating combustion chamber and the rotating power-extraction assembly prior to combustion initiation. The compressor assembly can include a crankshaft coupled with a reciprocating piston. The compressor assembly can include two or more crankshafts, with each crankshaft being coupled with at least one reciprocating piston. The combustion assembly can include a combustion chamber, and the engine further adapted to provide isolation between the combustion chamber and the rotating power-extraction assembly prior to combustion initiation.

A third aspect of the present invention provides a method of manufacturing a rotary internal combustion engine. The method includes providing a compressor assembly, coupling a combustion assembly with the compressor assembly so as to receive a compressed charge from the compressor assembly, and coupling a rotary power-extraction assembly with the combustion assembly so as to receive expansion gases discharged by the combustion assembly. The engine is adapted to provide isolation between the compressor assembly and the received compressed charge. The combustion assembly is adapted to initiate combustion after the isolation of the compressed charge and discharge expansion gases. The rotary power-extraction assembly is adapted to extract power from the received expansion gases.

A fourth aspect of the present invention provides another method of manufacturing a rotary internal combustion engine. The method includes providing a compressor assembly, coupling a combustion assembly with the compressor assembly so as to receive a compressed charge from the compressor assembly, and coupling a rotary power-extraction assembly with the combustion assembly so as to receive expansion gases discharged by the combustion assembly. The rotary power-extraction assembly is adapted to extract power from the received expansion gases. The rotary power-extraction assembly includes a housing including: a first cavity disposed within the housing and substantially defined by axial-symmetric walls; and a second cavity disposed within the housing and substantially defined by axial-symmetric walls, the second cavity intersecting the first cavity. A power rotor is rotationally disposed within the first cavity. The power rotor and the housing define an annular chamber therebetween. The power rotor includes a vane extending from the power rotor into the annular chamber. A sealing rotor is rotationally disposed within the second cavity, the sealing rotor including a recess sized to accommodate the vane during a rotation of the power rotor. An inlet is coupled with the combustion assembly and the annular chamber for the transfer of expansion gases from the combustion assembly to the annular chamber. An outlet is coupled with the annular chamber for the discharge of expansion gases from the annular chamber.

For a fuller understanding of the nature and advantages of the present invention, reference should be made to the ensuing detailed description and accompanying drawings. Other aspects, objects, and advantages of the invention will be apparent from the drawings and detailed description that follows.

### BRIEF DESCRIPTION OF THE DRAWINGS

FIG. 1 is a diagram showing the flow path of air through a rotary internal combustion engine in accordance with an embodiment of the present invention.

FIG. 2A is a cross-sectional diagram showing components of a reciprocating piston compressor assembly and associated rotating combustion chamber in accordance with an embodiment of the present invention when the pistons are at top dead center.

FIG. 2B shows the components of FIG. 2A at the end of the intake stroke when the pistons are at bottom dead center.

FIG. 2C shows the components of FIG. 2A part way into the compression stroke.

FIG. 2D shows the components of FIG. 2A at a point in the compression stroke when the compressed charges are starting to be transferred to the rotating combustion chambers.

FIG. 3A is an exploded view drawing of a cylinder head and rotating combustion chamber of a rotary internal combustion engine in accordance with one embodiment of the present invention.

FIG. 3B is a diagram showing the position of a combustion assembly exhaust piston valve and associated cam mechanism in accordance with one embodiment of the present invention when the piston valve is just starting to open.

FIG. 4A is a diagram showing a power rotor and sealing rotors of a rotary power-extraction assembly of a rotary internal combustion engine in accordance with an embodiment of the present invention at the start of a power cycle.

FIG. 4B shows the components of FIG. 4A near the end of a power cycle.

FIG. 4C shows the components of FIG. 4A at the end of a power cycle.

FIG. 4D shows the components of FIG. 4A when the vanes of the power rotor are passing by the sealing rotors.

FIG. 5A shows a plan view of a rotary internal combustion engine in accordance with one embodiment of the present invention.

FIG. 5B shows a front view of the engine of FIG. 5A.

FIG. 5C shows an end view of the engine of FIG. 5A.

FIG. 6A is perspective view of cross-sectional view CC of FIG. 5C.

FIG. 6B shows cross-section CC of FIG. 5C, which shows gears and sprockets used to provide coupling between various components of the engine embodiment shown.

FIG. 7A is a perspective view of cross-section DD of FIG. 5C.

FIG. 7B shows cross-section DD of FIG. 5C, which shows compressor assembly and combustion assembly components of the engine embodiment shown.

FIG. 8A is a perspective view of cross-section EE of FIG. 5C.

FIG. 8B shows cross-section EE of FIG. 5C, which shows rotary power-extraction assembly components of the engine embodiment shown.

FIG. 9 is an exploded view of components of an embodiment of a rotary internal combustion engine in accordance with the present invention.

FIG. 10 is an isolated view of region A of FIG. 9.

FIG. 11A shows an exemplary coupling between a sealing rotor and a crankshaft in accordance with an embodiment of the present invention.

FIG. 11B shows another exemplary coupling means that can be used to couple a sealing rotor and a crankshaft in accordance with an embodiment of the present invention.

FIG. 12 shows an exemplary power rotor with attached vanes in accordance with an embodiment of the present invention.

FIG. 13 is a perspective view showing the spatial arrangement of a rotating combustion chamber, a fuel injector, an exhaust piston valve assembly, and cam mechanism in accordance with an embodiment of the present invention.

FIG. 14 is a cross-sectional view of an installed rotating combustion chamber and associated entry seal showing the location of the fuel injector, in accordance with an embodiment of the present invention.

FIG. 15 is a cross-sectional view of a cylinder head and rotating combustion chamber showing the location of the fuel injector, piston valve, and routing path for expansion gases transferred to the rotary-power extraction assembly, in accordance with an embodiment of the present invention.

FIG. 16 is a cross-sectional view of the cylinder block and main shaft showing the location of supporting roller bearings, in accordance with an embodiment of the present invention.

### DETAILED DESCRIPTION OF THE INVENTION

The invention described herein provides rotary internal combustion (IC) engines and related methods.

The presently disclosed invention provides rotary IC engines with novel design features that may provide a number of benefits relative to existing IC engines. For example, the present invention may provide improved power extraction over conventional reciprocating piston engines by extracting power from expansion gases in a rotary power-extraction assembly. The rotary power-extraction assembly of the presently disclosed invention is also generally dedicated to power extraction, which may produce more balanced forces during power extraction, and may result in more power produced per weight of the rotary power-extraction assembly.

In addition, the rotary IC engines may enable the use of an increased compression ratio, which may result in an additional increase in efficiency. The disclosed rotary IC engines can isolate the compressor assembly from being impacted by the pressures generated by the internal combustion of fuel. The isolation of the compressor assembly, and the use of a rotary power-extraction assembly, may provide for increased fuel flexibility by employing an approach that may be less sensitive to fuel burn rate than conventional reciprocating piston engines. As a result, the present invention may provide increased flexibility to use a higher compression ratio than may be possible with conventional reciprocating piston engines using any particular fuel.

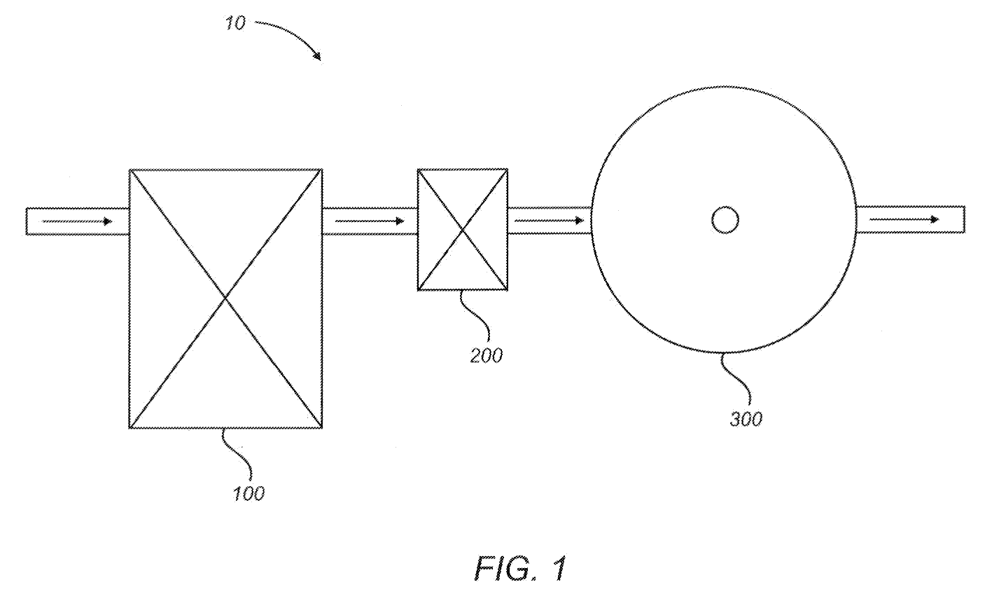

Turning now to the drawings, attention is first directed to FIG. 1. This figure shows, in simplified form, a rotary IC engine 10 according to an embodiment of the present invention. The rotary IC engine 10 of FIG. 1 includes a compressor assembly 100, a combustion assembly 200 coupled with the compressor assembly 100, and a rotary power-extraction assembly 300 coupled with the combustion assembly 200. In operation, air is inducted into the compressor assembly 100, where it is compressed and subsequently delivered to the combustion assembly 200. At some point along the way, fuel is added to the air so that combustion may be initiated within the combustion assembly 200. While it is presently preferred to add fuel at the combustion assembly 200 by way of direct injection, it should be appreciated that fuel may be added to the air at various points upstream of the combustion assembly 200 by various means well know in the art without deviating from the scope of the presently disclosed invention. The combustion assembly 200 provides a location where combustion may be initiated. Once combustion is initiated, expansion gases are transferred to the rotary power-extraction assembly 300, which is configured to extract power from the received expansion gases. Although the combustion process may be completed within the combustion assembly 200, it is not necessary. The combustion process may continue to occur as power is extracted from the expansion gases by the rotary power-extraction assembly 300. In one embodiment, the rotary IC engine 10 is adapted to provide isolation between the compressor assembly 100 and the expansion gases, which are typically at a much higher temperature and pressure than the compressed charge supplied by the compressor assembly 100 due to the added thermal energy from the combustion process. It should be appreciated that various approaches may be used to isolate the compressor assembly 100 from the expansion gases. For example, an isolation feature can be located downstream of the compressor assembly, such as a valve.

The use of a rotary-power extraction assembly 300 avoids problems associated with conventional reciprocating piston engines. Unlike conventional piston engines, the rotary power-extraction assembly 300 has a substantially constant moment arm, which may provide more efficient extraction of power. The rotary power-extraction assembly 300 may also be less sensitive to fuel burn rate, thereby allowing increased flexibility in the choice of fuel.

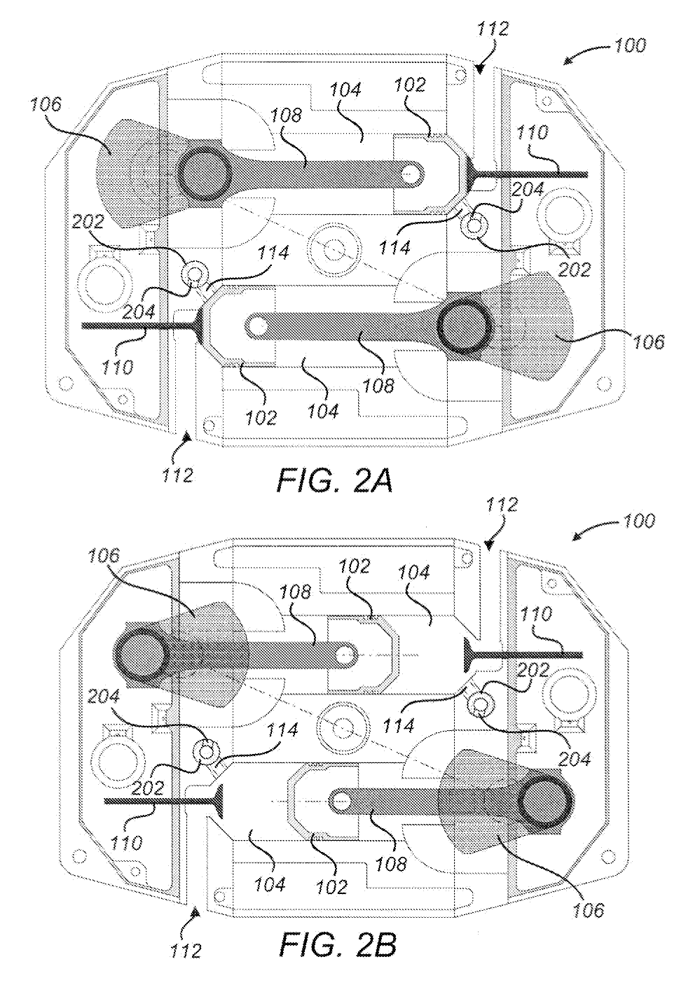

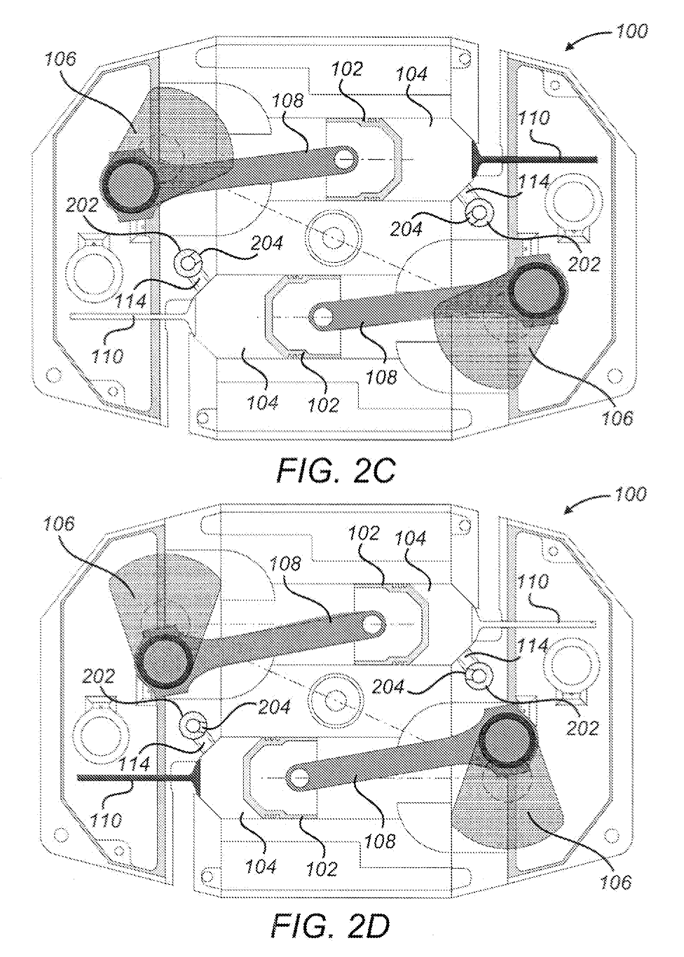

Turning now to FIGS. 2A through, 2D, the components and operational phases of an exemplary compressor assembly 100 and combustion assembly 200 in accordance with the present invention will be described. FIG. 2A shows a compressor assembly 100 that includes two pistons 102 located at top dead center. As shown, the pistons 102 are disposed within cylinders 104 and are connected to crank shafts 106 by way of connecting rods 108. Intake valves 110 are provided to regulate the flow of air by allowing the intake of air from intake passages 112 into the cylinders 104 during the intake stroke, while blocking the air from escaping during the compression stroke. As shown, when the pistons 102 are located at top dead center, the intake valves 110 shown are in the closed position, thereby avoiding interfering with the pistons 110. However, it should be appreciated that the intake valves 110 may be at least partially open at top dead center as long as there is clearance with the pistons 102, and sufficient blocking of the flow of air during a compression stroke is provided. As shown, the top dead center location of the pistons 102 occurs at the start of an intake stroke.

Located adjacent to the intake valves 110 are rotating combustion chambers 202 and associated transfer ducts 114. The rotating combustion chambers 202 include a traverse opening 204 that serves to provide an intermittent path by which the compressor assembly 100 can transfer a compressed charge to the rotating combustion chamber 202, and by which the compressed charge can be subsequently isolated from the compressor assembly 100. The rotating combustion chambers 202 in the embodiment shown rotate in a clockwise direction. As shown in FIG. 2A, when the pistons 102 are located at top dead center, each traverse opening 204 of the rotating combustion chambers 202 has just rotated beyond its associated transfer duct 114, thereby isolating the contents of the rotating combustion chambers 202 from the compressor assembly 100.

FIG. 2B shows the location of the components at the end of the intake stroke. As shown, the pistons 102 have reached bottom dead center. Although the intake valves 110 are shown open, they will be closed in short order during the following compression stroke. As will be discussed in more detail later, the timing of the intake valves 110 may be controlled by way of a rotary cam, as are well known in the art. The rotating combustion chambers 202 have rotated by 180 degrees during the intake stroke, as can be seen by comparing the orientation of the traverse openings 204 shown in FIG. 2A with the orientation of the traverse openings 204 shown in FIG. 2B. As such, the contents of the rotating combustion chambers 202 continue to be isolated from the compressor assembly 100 during the intake stroke.

FIG. 2C shows the location of the components part way into the compression stroke. The intake valves 110 have been closed at the start of the compression stroke, and remain closed. As shown, the crank shafts 106 have rotated in a counter-clockwise direction relative to their bottom dead center orientations of FIG. 2B. The pistons 102 have traveled part way toward the intake valves 110, thereby partially compressing the contents of the cylinders 104. At this point in the compression stroke, the rotating combustion chambers 202 have rotated an additional amount relative to their positions of FIG. 2B, but are still in an orientation that continues to isolate the contents of the rotating combustion chambers 202 from the compressor assembly 100.

FIG. 2D shows the position of the components at the point in the compression stroke after which the rotating combustion chambers 202 will be oriented to accept a compressed charge from the compressor assembly 100. As shown, the rotating combustion chambers 202 have rotated to a point where the traverse openings 204 are just beginning to encounter the associated transfer ducts 114. Further rotation of the crank shafts 106 and rotating combustion chambers 202 will result in the transfer of the compressed charge to the rotating combustion chambers 202 by way of the associated transfer ducts 114 and traverse openings 204. As can be seen by referring back to FIG. 2A, when top dead center is reached at the end of the compression stroke, the rotating combustion chambers 202 have rotated to an orientation that begins the rotational segment where the contents of the rotating combustion chambers 202 are once again isolated from the compressor assembly 100.

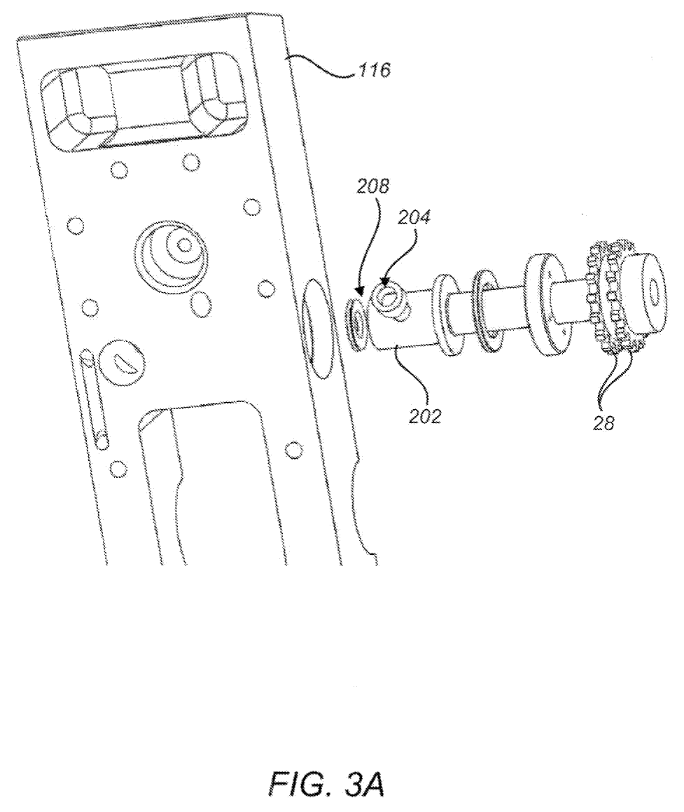

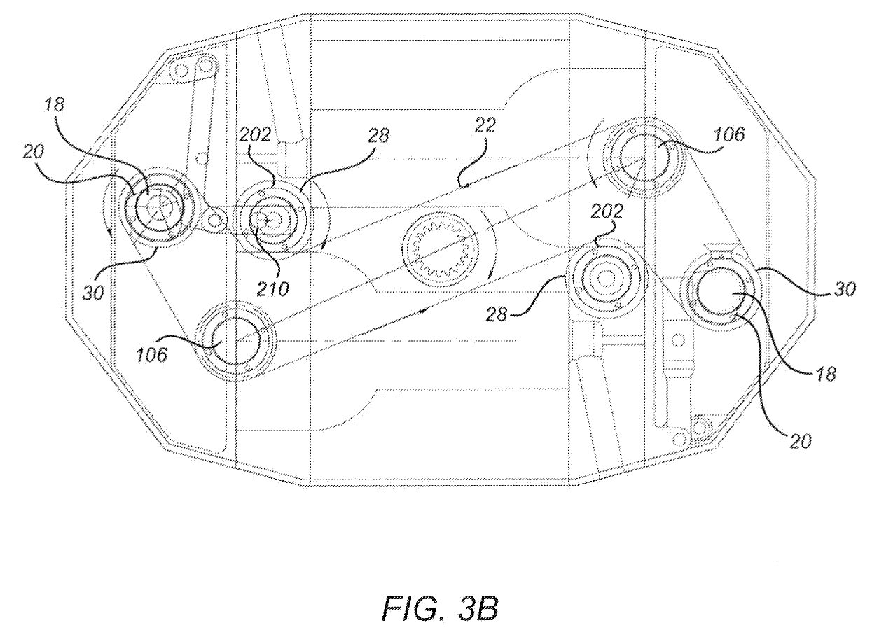

Referring now to FIG. 3A, an exploded view is presented that shows details of a rotating combustion chamber 202 relative to the cylinder head 116 in which it is disposed. At one end of the rotating combustion chamber 202 is a dual sprocket 28, which is driven by a timing chain 22 (shown in FIG. 3B) so as to synchronize the rotating combustion chamber 202 with the compressor assembly 100, as well as with other parts of the engine, such as the rotary power-extraction assembly 300. At the other end of the rotating combustion chamber 202, the traverse opening 204 is shown. Adjacent to the traverse opening 204, the rotating combustion chamber 202 has a central opening 208, so as to provide a path for the discharge of expansion gases.

FIG. 3B shows the position of a combustion assembly exhaust piston valve 210 and associated actuating cam mechanism 18 when the piston valve 210 is just starting to open. As can be appreciated by inspecting the cam profile 20 shown, the piston valve 210 will be kept open for a significant period of time, thereby providing sufficient time for the discharge of expansion gases from the rotating combustion chamber 202. Also shown, is the path and direction of travel of a timing chain 22, which interconnects sprockets located on each crank shaft 106, each rotating combustion chamber 202, and each associated actuating cam mechanism 18, thereby synchronizing the motion of these components with one another.

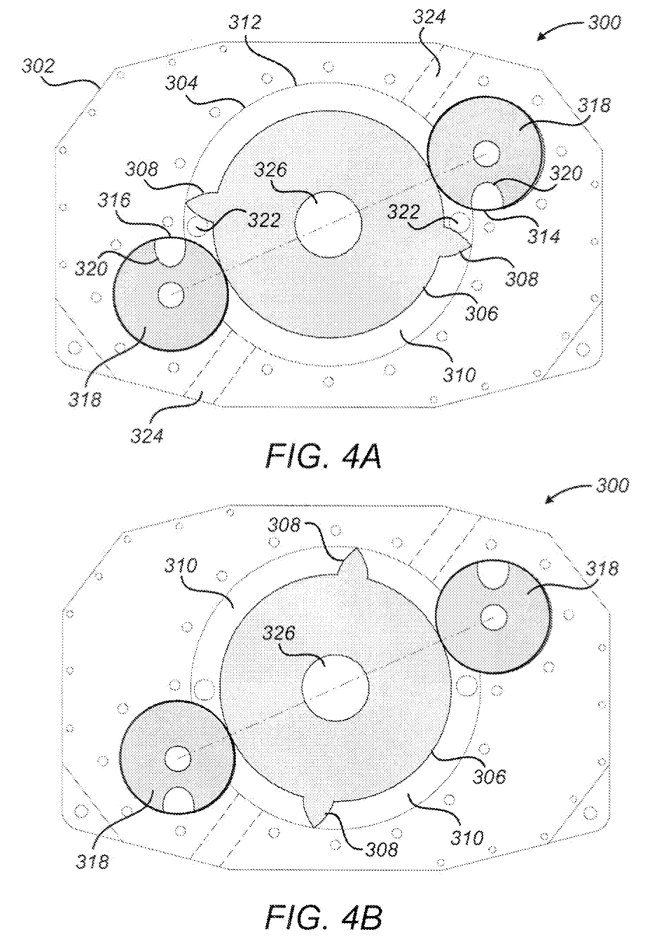

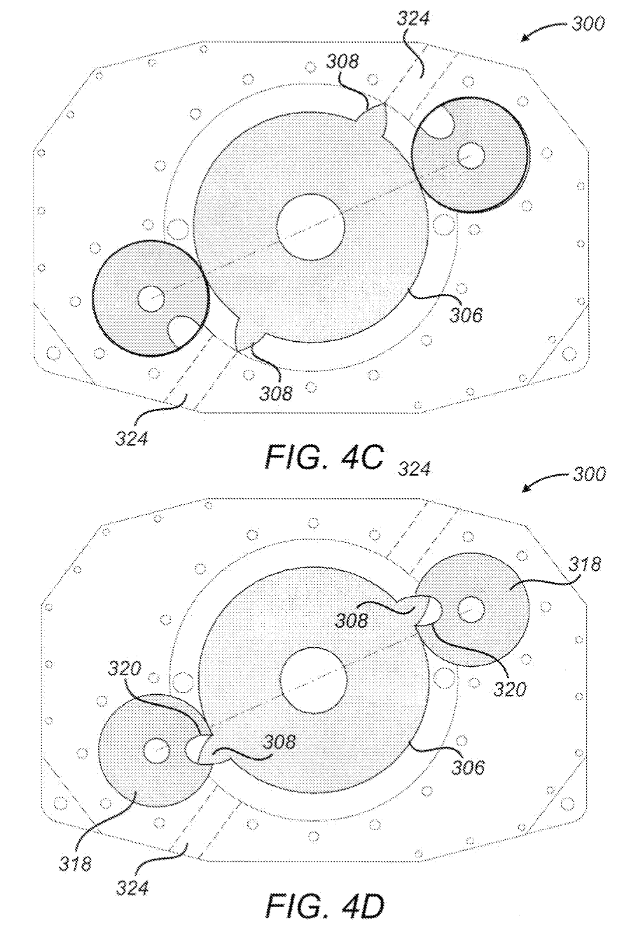

Expansion gases discharged by the combustion assembly 200 are transferred to the rotating power-extraction assembly 300. Turning now to FIGS. 4A through 4D, the primary components and operational phases of an exemplary rotary power-extraction assembly 300 in accordance with the present invention will be described. FIG. 4A depicts a housing 302 and associated first recess 304 in which a power rotor 306 is rotationally disposed. In the embodiment shown, the first recess 304 and power rotor 306 are basically cylindrical in shape. However, the first recess 304 and power rotor 306 may also be axial-symmetric in shape and still function due to the rotation occurring about a single axis. Protruding from the power rotor 306 are two vanes 308. These vanes 308 protrude into the annular chamber 310 located between the power rotor 306 and the walls 312 of the first recess 304. The housing 302 further includes a second recess 314 and a third recess 316, which partially intersect the first recess 304. Two sealing rotors 318 are rotationally disposed within the second recess 314 and third recess 316 respectively. As shown, the two sealing rotors 318 include recessed portions 320. In operation, the rotation of the sealing rotors 318 are synchronized with the rotation of the power rotor 306 so as to produce rolling contact between the sealing rotors 318 and the power rotor 306. Two oppositely oriented supply ports 322 are positioned to supply expansion gases to the annular chamber 310. Likewise, two oppositely oriented exhaust passages 324 are located to provided for the discharge of expansion gases from the annular chamber 310.

FIG. 4A shows the location of the components at the start of a power stroke. At this point, expansion gases discharged by the combustion assembly 200 are transferred to the annular chamber 310 through the two supply ports 322. As shown, the expansion gases are isolated to two regions of the annular chamber 310 that are bounded by the vanes 308 and the adjacently located sealing rotors 318, thereby subjecting one side of the vanes 308 to high pressure expansion gases. On the other side of the vanes, the other two regions of the annular chamber 310 are open to the exhaust passages 324, thereby subjecting the opposite sides of the vanes 308 to relatively low pressure. The differential pressure on the vanes 308 results in net forces upon the vanes 308, which produce a torque on an output shaft 326 that is coupled with the power rotor 306. As a result, the output shaft 326 is rotationally driven, thereby extracting power from the expansion gases.

FIG. 4B shows the location of the components near the end of a power stroke. At this point, the volume of the two regions of the annular chamber 310 into which the expansion gases were fed has increased, thereby providing for expansion of the expansion gases. During this expansion, the resulting differential pressure on the vanes 308 has continued to result in net force being applied to the vanes 308, which continues to produce torque on the output shaft 326. As can be seen by comparing FIG. 4A with FIG. 4B, the power rotor 306 is rotating in a clockwise direction, while the sealing rotors 318 are rotating in a counter-clockwise direction, thereby producing rolling contact as discussed above. As shown, the sealing rotors 318 are configured to isolate adjacent regions of the annular chamber 310 throughout the duration of the power stroke. The embodiment shown subjects the power rotor 306 to a relatively balanced force couple, thereby minimizing unbalanced traverse forces applied to the power rotor 306. It should be appreciated that this balanced loading can provide for increased reliability and improved operational characteristics.

FIG. 4C shows the location of the components at the end of a power stroke. At this point, the power rotors 306 have rotated as far as they can prior to the vanes 308 starting to pass by the exhaust passages 324. Further rotation will open a path by which the expansion gases may be discharged via the exhaust passages 324. Due to the expansion of the expansion gases that has occurred during the power stroke, the pressure of the expansion gases at the end of the power stroke can be less than at the start of the power stroke.

FIG. 4D shows the location of the components after the end of a power stroke, but before the beginning of the next power stroke. At this point, the vanes 308 are starting to pass by the sealing rotors 318 as provided for by the recessed portions 320 of the sealing rotors 318. Additional rotation of the power rotor 306 and sealing rotors 318 will place the power rotor 306 180 degrees from its position of FIG. 4A, and in position for the start of another power stroke. As such, the rotary power-extraction assembly 300 accomplishes two balanced power strokes during a single complete rotation of the power rotor 306. As will be appreciated by a person of skill in the art, this provides substantially continuous power extraction, which may provide substantial associated benefits, such as increased reliability and reduced component weight.

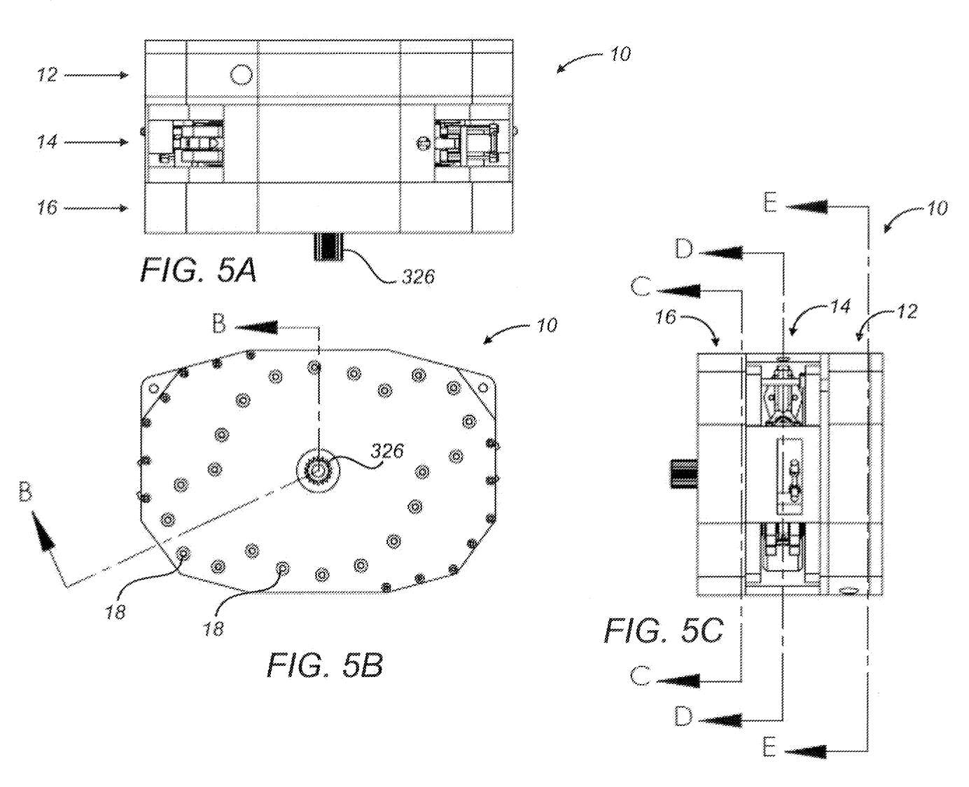

FIG. 5A shows a plan view of a rotary IC engine 10 in accordance with an embodiment of the present invention. The rotary IC engine 10 shown includes an output shaft 326 used to transmit the mechanical power generated by the rotary IC engine 10. The rotary IC engine 10 shown has three distinct portions, including: a) a rotary power-extraction assembly portion 12; b) a middle portion 14 containing the compressor assembly 100 and combustion assembly 200; and c) an interconnection portion 16, which provides mechanical interconnections between components of the rotary IC engine 10 shown.

As can be seen in both FIGS. 5A and 5C, the rotary IC engine 10 embodiment shown includes an output shaft 326 that protrudes from only one side of the engine. On the side opposite the protruding output shaft 326, the rotary IC engine 10 can be adapted to receive a protruding output shaft 326 of an adjacent engine unit (not shown). This configuration allows for this embodiment to be stacked, thereby harnessing the mechanical output of two or more engine units. Both sides of the rotary IC engine 10 can be adapted to couple with various other assemblies, such as a starter motor, and engine accessories such as power steering units, air conditioning units, alternators, and the like.

FIG. 5B shows a front side view of the rotary IC engine 10 of FIG. 5A. This view shows various assembly bolts 18, as well as the protruding output shaft 326.

FIG. 5C shows an end view of the rotary IC engine 10 of FIG. 5A. FIG. 5C also shows the location of section CC, which is located at the interconnection portion 16 of the rotary IC engine 10; section DD, which is located at the middle portion 14 containing the compressor assembly 100 and the combustion assembly 200; and section EE, which is located at the rotary power-extraction assembly portion 12.

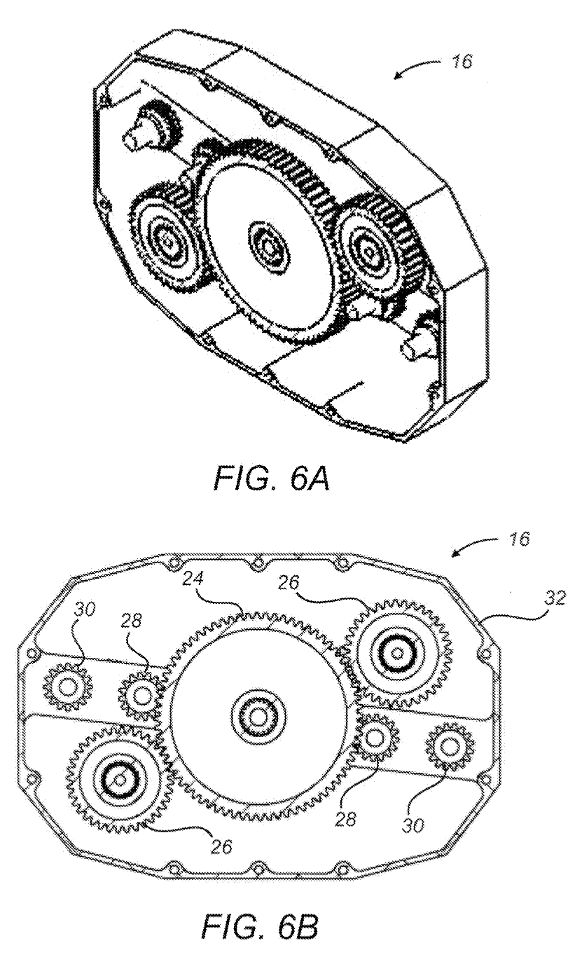

FIGS. 6A and 6B show section CC of FIG. 5C, which illustrates components of the interconnection portion 16 of the rotary IC engine 10 embodiment, from two view directions. The centrally located output shaft 326 mechanically couples the main gear 24 with the power rotor 306 of the rotary power-extraction assembly 300. The main gear 24 meshes with two crankshaft gears 26, which drive the two crankshafts 106 of the compressor assembly 100. In the embodiment shown, the main gear 24 has a pitch diameter of 9 inches, and each of the crankshaft gears 26 has a pitch diameter of 4.5 inches. Having a main gear 24 that is twice the diameter of the crankshaft gears 26 results in two revolutions of each crankshaft gear 26 for every one revolution of the main gear 24; this provides the two compression and combustion cycles required to support the two power strokes during a single rotation of the power rotor 306 of the rotary power-extraction assembly 300.

The interconnection portion 16 also contains a set of smaller diameter sprockets that mechanically couple the rotating combustion chambers 202 and cam mechanisms 18 with the two crankshafts 106 by way of a timing chain 22 (shown in FIG. 3B). There are two rotating combustion chamber sprockets 28 and two cam mechanism sprockets 30. There are also two crankshaft sprockets (not shown), each of which are located behind the two crankshaft gears 26. The cam mechanisms 18 provide actuation for the intake valves 110 of the compressor assembly 100 and the exhaust piston valves 210 of the combustion assembly 200. Each of the sprockets used has the same diameter, thereby synchronizing the revolutions of the rotating combustion chambers 202 and cam mechanisms 18 with the crankshafts 106.

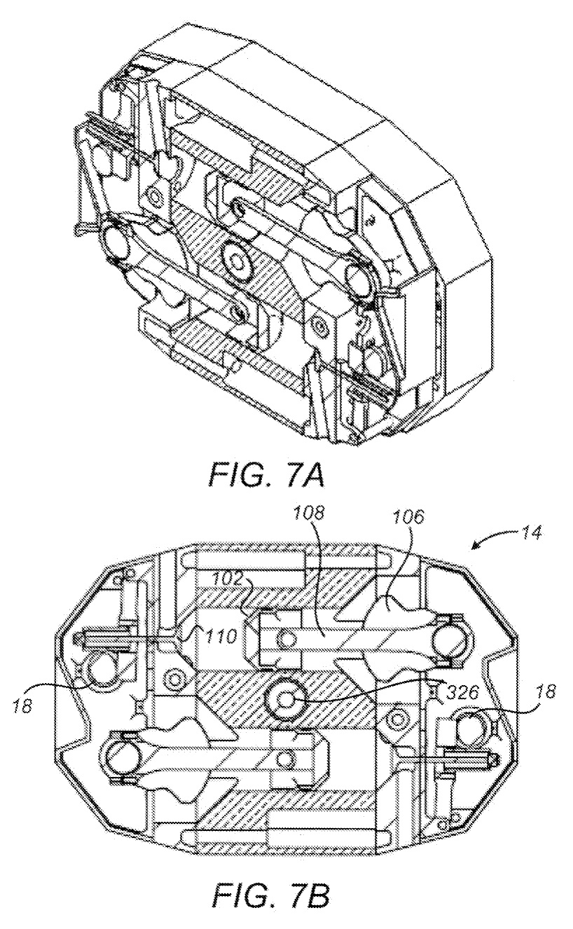

FIGS. 7A and 7B show a cross-section of the rotary IC engine 10 taken along section DD of FIG. 5C, which illustrates components of the compressor assembly 100 and the combustion assembly 200 of the rotary IC engine 10 embodiment, from two view directions. Also shown, is the centrally located output shaft 326, which passes through the middle portion 14 of the engine so as to connect the main gear 24 of the interconnection portion 16 with the power rotor 306 of the rotary power-extraction assembly portion 12. The location of cam mechanisms 18 are also shown. Locations of pistons 102, connecting rods 108, crankshafts 106, and intake valves 110, as discussed above in connection with FIGS. 2A, 2B, 2C, and 2D, are also shown. The middle location for the compressor assembly 100 and combustion assembly 200 places these assemblies directly adjacent to the rotary power-extraction assembly 300, thereby allowing a more direct transfer of expansion gases from the combustion assembly 200 to the rotary power-extraction assembly 300.

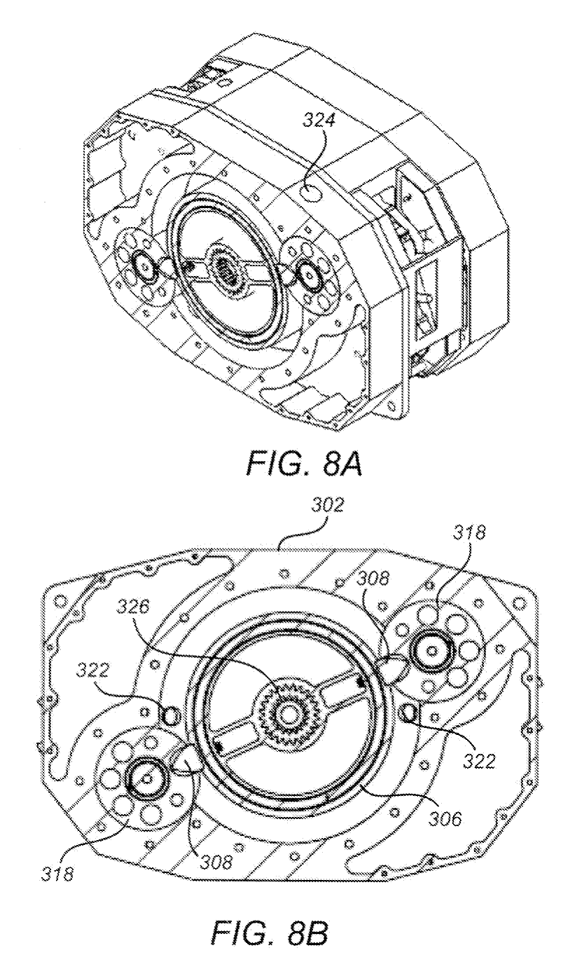

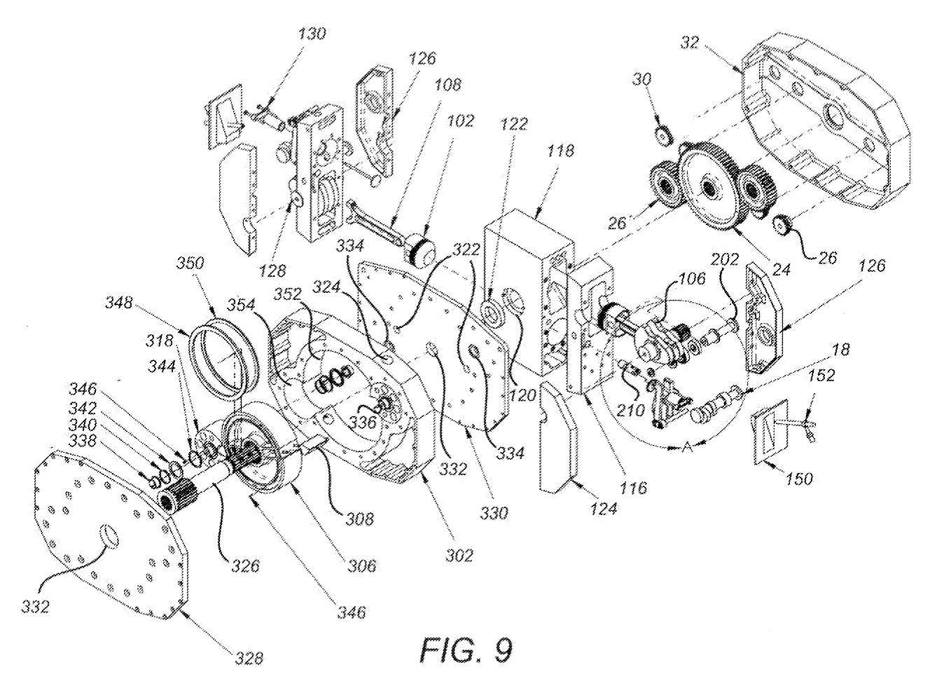

FIGS. 8A and 8B show a cross-section of the rotary IC engine 10 taken along section EE of FIG. 5C, which illustrates components of the rotary power-extraction assembly 300 of the rotary IC engine 10 embodiment, from two view directions. FIGS. 8A and 8B illustrate the locations of the housing 302, the power rotor 306, the output shaft 326 that mechanically couples the power rotor 306 with the main gear 24 of the interconnection portion 16, the power rotor vanes 308, the sealing rotors 318, and the supply ports 322. The exit location of one of the exhaust passages 324 is shown in FIG. 8A. The cross-section shown corresponds to an interface between an expansion chamber outer plate 328 (shown in FIG. 9) and the rest of the rotary power-extraction assembly 300.

FIG. 9 provides an exploded view of components of an embodiment of the rotary IC engine 10. The rotary power-extraction assembly 300 is bounded by an outer plate 328 on one side, and an inner plate 330 on another side. The components of the interconnection portion 16 are disposed on the opposite side of the rotary IC engine 10. The components of the compressor assembly 100 and the combustion assembly 200 are located between the rotary power-extraction assembly 300 and the interconnection portion 16.

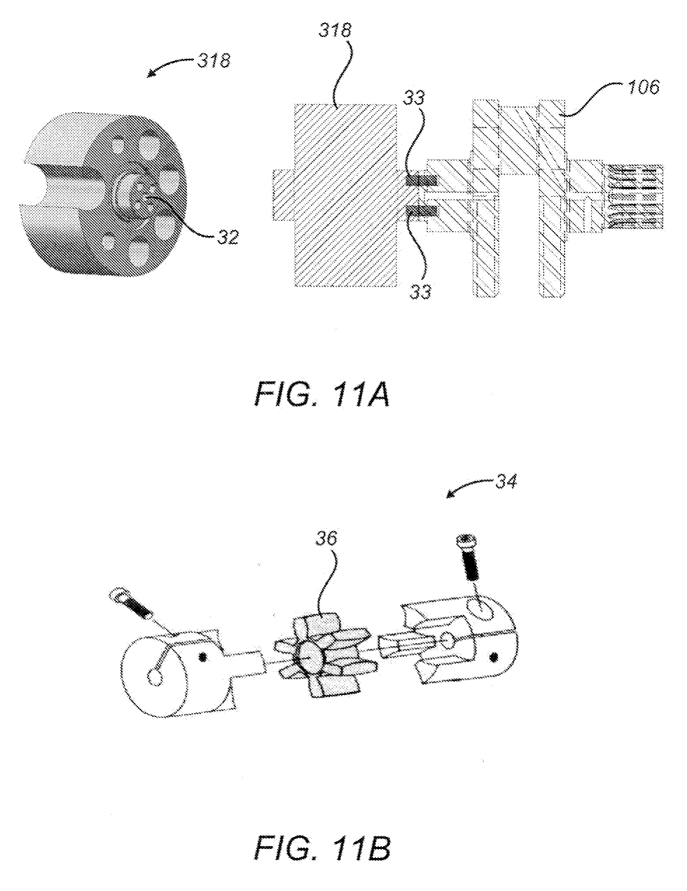

The components of the rotary power-extraction assembly portion 12 will now be described. The base structure is built up from three separate components, an inner plate 330, a rotor housing 302, and an outer plate 328. The combination of these three components provides the intersecting recesses in which the power rotor 306 and the sealing rotors 318 are rotationally disposed. The inner plate 330 and outer plate 328 provide support for the sealing rotors 318, which are aligned with centerlines of the crankshafts 106 and mechanically coupled with the crankshafts 106. It should be appreciated that a variety of ways may be used to mechanically couple the sealing rotors 318 to the crankshafts 106. For example, FIGS. 11A and 11B illustrates two such ways. In FIG. 11A, a sealing rotor 318 and a crankshaft 106 can include mating holes 32 for shear pins 33, which serve to transfer rotary motion from the crankshaft 106 to the sealing rotor 318. FIG. 11B illustrates another way to couple a sealing rotor 318 to a crankshaft 106, which involves coupling connector fittings 34 with the sealing rotor 318 and the crankshaft 106. The connector fittings 34 shown are designed to couple with each other by way of an intermediate coupling element 36.

The inner plate 330 and outer plate 328 each have a centrally located opening 332 for the output shaft 326. Although not shown, it should be appreciated that an appropriate oil seal as are well know in the art can be located at opening 332 so as to provide sealing around output shaft 326. The inner plate 330 has two supply ports 322 for the transfer of expansion gases from the rotating combustion chambers 202 to the annular chambers 310 as discussed above in connection with FIGS. 4A, 4B, 4C, and 4D. The inner plate 330 and the outer plate 328 contain bearing recesses 334 for support of the sealing rotor journals 336 using bronze bushings (only one shown for clarity), like the single bronze bushing 338 shown. Teflon seal rings 340, oil seals 342, and wave springs 344, (only one of which are shown for clarity), are located on both sides of the sealing rotors 318, and are sandwiched between the sealing rotors 318 and the bronze bushings 338. 0.125 inch diameter pins 346 (one shown for clarity) are used to keep the oil seals 342 spinning with the sealing rotors 318 so as to avoid having the oil seals 342 spinning relative to the wave springs 344, which may be made from 17-7PH stainless steel and be susceptible to galling. The sealing rotors 318 have an outside diameter of 4.5 inches, and the power rotor 306 has an outside diameter of 9 inches; this ratio of diameters produces rolling motion between the sealing rotors 318 and the power rotor 306 due to the sealing rotors 318 rotating twice for every rotation of the power rotor 306. Power-rotor oil seals 348 (one shown for clarity) are provided between the power rotor 306 and the outer plate 328, and between the power rotor 306 and the inner plate 330. Wave springs 350 (one shown for clarity) are provided between the power-rotor oil seals 348 and the power rotor 306. 0.125 inch diameter pins 346 are used to keep the power-rotor oil seals 348 spinning with the power rotor 306 so as to avoid having the power-rotor oil seals 348 spinning relative to the wave springs 350.

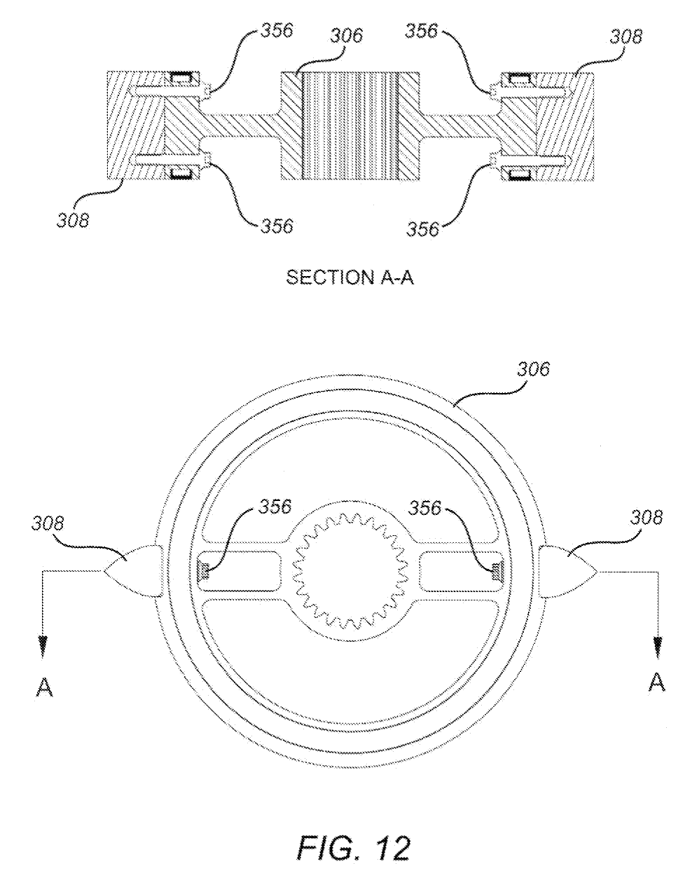

The rotor housing 302 has a large central opening 352 into which the power rotor 306 is rotationally disposed, with the large central opening 352 being larger than the diameter of the power rotor 306 so as to provide the annular chamber 310 discussed above. The rotor housing 302 has two smaller openings 354 that intersect the large central opening 352. The sealing rotors 318 are rotationally disposed within the two smaller openings 354 as shown. The two vanes 308 are mechanically coupled with the power rotor 306. The connection between a vane 308 and the power rotor 306 is shown in FIG. 12, and includes a recess in the outer surface of the power rotor 306 dimensioned to receive a vane 308, which is bolted to the power rotor 306 using two protruding head bolts 356 located on opposite sides of the centerline plane of the power rotor 306.

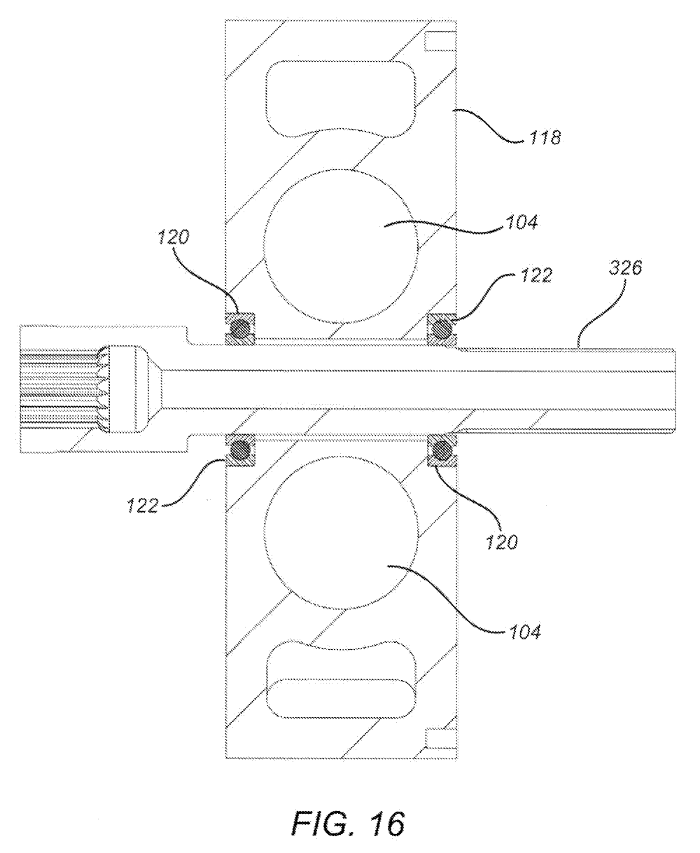

The components of the middle portion 14 of the rotary IC engine 10 embodiment will now be described. A cylinder block 118 having the two cylinders 104 of the compressor assembly 100 is located in the middle portion 14 of the rotary IC engine 10. As can be seen in FIG. 9 and FIG. 16, the cylinder block 118 includes two mounting recesses 120 located on opposite sides of the block for mounting main-shaft ball bearings 122, which support the main shaft 326. The cylinder block 118 receives the two pistons 102, which are connected by connecting rods 108 to respective crankshafts 106. Two specialized cylinder heads 116 are attached to opposite sides of the cylinder block 118. The crankshafts 106 are supported by crankshaft bearings (not shown), which are supported by the specialized cylinder heads 116, as well as by the attached left hand valve covers 124 and the attached right hand valve covers 126, which function in part as journal caps for the crankshaft journals 128. The specialized cylinder heads 116 are configured to receive and support the intake valves 110. The specialized cylinder heads 116 are configured to receive the rotating combustion chambers 202, which are located along axes of rotation that align with the two supply ports 322 in the expansion chamber inner plate 330. An intake valve assembly 130 is coupled with each specialized cylinder head 116. Actuation of the intake valve assembly 130 is provided by a cam mechanism 18, which is supported by the left hand valve cover 124 and the right hand valve cover 126, and is driven by way of a cam mechanism sprocket 30 located in the interconnection portion 16 of the engine. The cam mechanism 18 further provides actuation to the combustion assembly exhaust piston valve 210, which is received in a piston valve recess that is disposed at right angles with, and intersects a rotating combustion chamber recess in the specialized cylinder head 116 in which the rotating combustion chamber 202 is rotationally disposed.

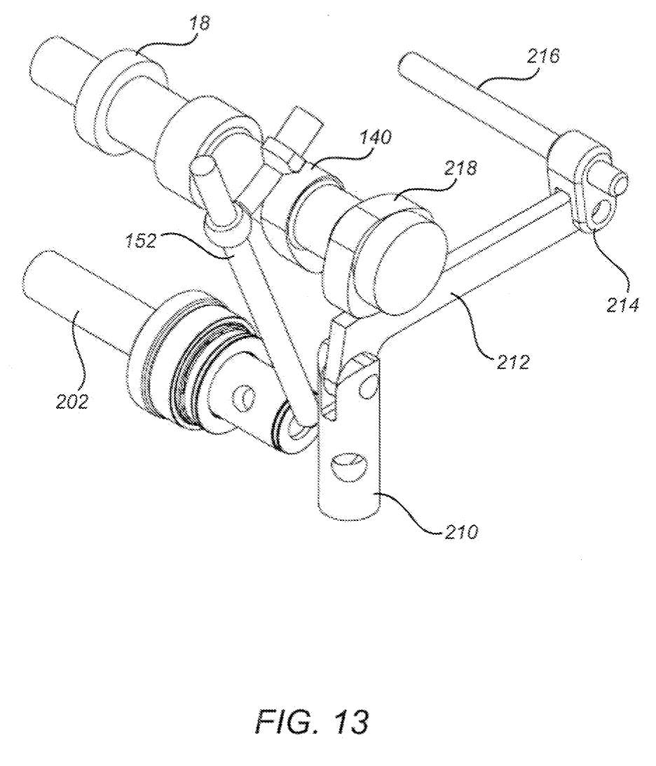

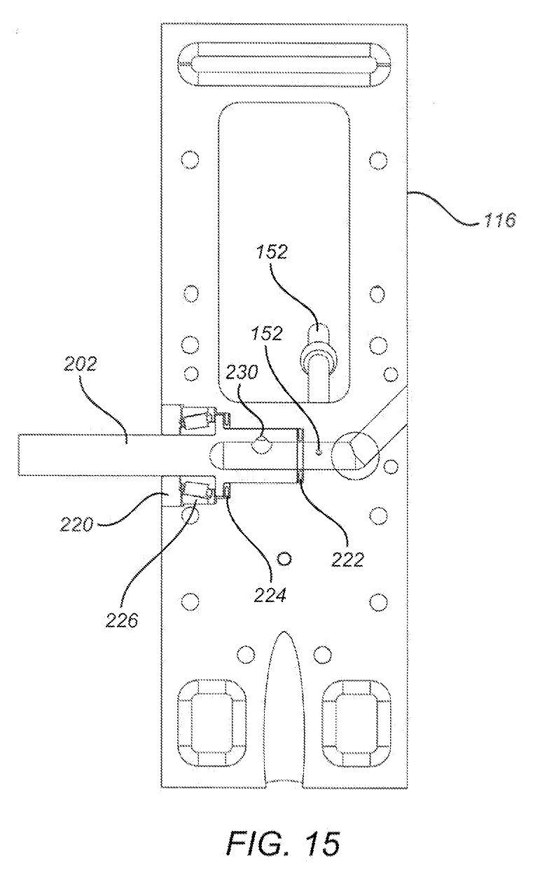

An injector housing 150 and associated fuel injector 152 is coupled with the specialized cylinder head 116 so as to supply fuel to the engine. The fuel injector 152 used can be a pencil injector, such as a Stanadyne 20688. FIGS. 13, 14, and 15 shows the fuel injector 152 relative to the rotating combustion chamber 202 components. The tip of the fuel injector 152 is located between the rotating combustion chamber 202 and the piston valve 210 (not shown).

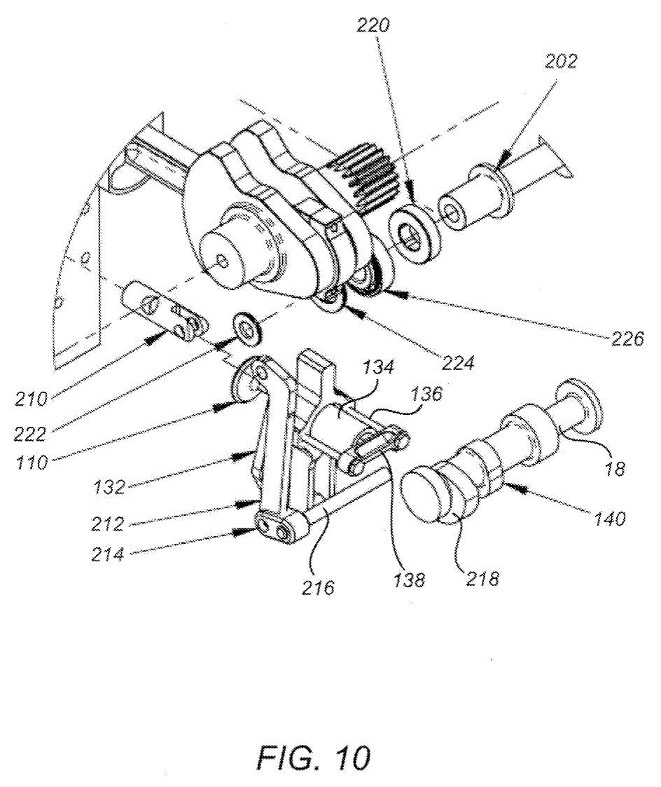

FIG. 10 shows a close-up view of region A of FIG. 9. The combustion assembly exhaust piston valve 210 is connected to the piston valve rocker arm 212, which is itself connected with a swing link 214. As best seen in FIG. 13, the piston valve 210 is constrained to axial movement by its interface with the cylinder head and its interface with the rocker arm 212. The swing link 214 is mounted on a support shaft 216. The swing link 214 provides support for the rocker arm 212 while allowing the rocker arm 212 to translate the small lateral amounts required by the motion of the piston valve 210. In operation, the rocker arm 212 is held in contact with the cam mechanism 18 by way of a compression spring (not shown) located between the piston valve 210 and the bottom of the piston valve recess in the cylinder head 116. It should be appreciated that a variety of approaches may be used to actuate the piston valve 210. For example the piston valve 210 may be actuated by way of an electric solenoid. It should also be appreciated that a variety of approaches may be used to provide isolation between the combustion chamber and the rotary power-extraction assembly prior to combustion initiation.

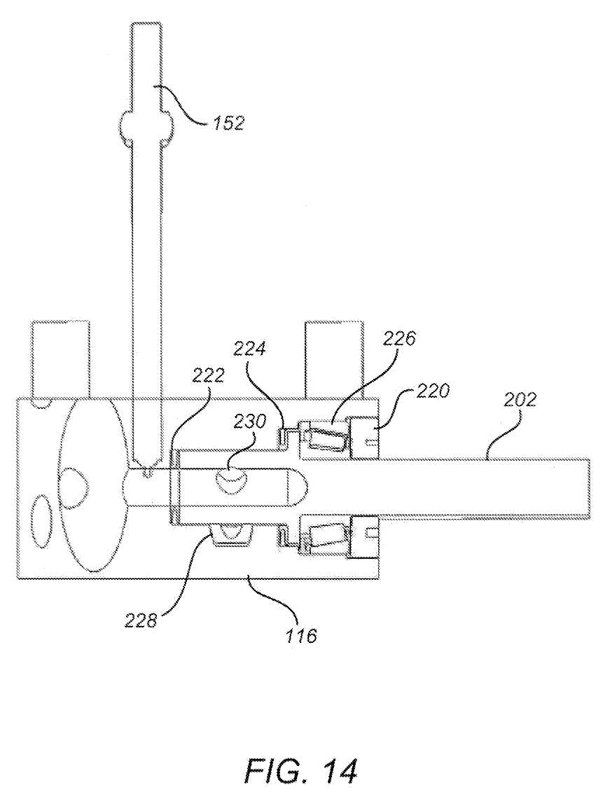

The intake valve 110 is supported by a valve bracket 132, which also supports a valve spring 134, as well as guide rods 136 and associated intake valve interface member 138. The cam mechanism 18 has an intake valve lobe 140 which contacts and displaces the intake valve interface member 138 to cycle the intake valve 110 in synchronization with the compressor assembly 100. The cam mechanism 18 has a piston valve lobe 218 which contacts and displaces the piston valve rocker arm 212 to cycle the piston valve 210 in synchronization with its associated rotating combustion chamber 202. As can be best seen in FIG. 14, the rotating combustion chamber 202 includes a retaining nut 220, which keeps the rotating combustion chamber 202 in place against the pressure against the closed end of the chamber, and provides preload of the inner ring seal 222 and the outer ring seal 224. The tapered roller bearing 226 reacts thrust load from the rotating combustion chamber 202, while providing for axial rotation. The inner ring seal 222 and the outer ring seal 224 provide sealing between the rotating combustion chamber 202 and the cylinder head 116, while allowing for some axial expansion of the rotating combustion chamber 202, which will operate at a higher temperature than the cylinder head 116. The rotating combustion chamber 202 may be made from Inconel material so as to withstand the higher temperatures seen. To account for Inconel having a higher coefficient of expansion than the adjacent steel cylinder head 116, the inner ring seal 222 and the outer ring seal 224 are slotted and machined with a slant on the sides, to make them act like little springs. The entry seal 228 seals the entrance port 230, through which the compressed charge is received from the compressor assembly 100, while allowing for radial expansion of the rotating combustion chamber 202.

Referring back to FIG. 9, the components of the interconnecting portion 16 of the rotary IC engine 10 embodiment will now be described. The output shaft 326 is connected to the 9 inch main gear 24 by a splined coupling. The 9 inch main gear 24 meshes with two 4.5 inch crankshaft gears 26, thereby providing for two revolutions of the crankshafts 106 for every one revolution of the main gear 24; this two to one ratio supports the two power-strokes during each revolution of the power rotor 306 as discussed above. The interconnection portion 16 includes a gear housing 32, which serves to enclose the gears, sprockets, and timing chain 22 (shown in FIG. 3B) of the interconnection portion 16. The gear housing 32 includes sprocket recesses 34 that provide support for the rotating combustion chamber sprockets 28 (shown in FIG. 6B), as well as for the cam mechanism sprockets 30. The cam mechanism sprockets 30 are standard double roller chain sprockets. The gear housing 32 further includes a centrally located opening 35 to provide for coupling of additional engine stages or accessories with output shaft 326. Although not shown, it should be appreciated that an appropriate oil seal as are well know in the art can be located at opening 35 so as to provide sealing around output shaft 326.

The present invention further provides methods of manufacture for the presently disclosed rotary IC engines. These methods involve providing and assembling various components, which are in accordance with the present invention. These components include a compressor assembly, a combustion assembly, and a rotary power-extraction assembly.

The design and construction of rotary IC engines in accordance with the present invention can involve consideration of, and balancing between, numerous and complex design parameters. The choices made with regard to these design parameters will influence the resulting engine size, weight, power output, torque output, operating RPM range, reliability, and cost. As such, the design of these rotary IC engines can involve an iterative process, where the impact of variations in design parameters upon the top-level characteristics of the engine can be used in deciding what combination of design choices leads to an optimized engine design.

The resulting size of the presently disclosed rotary IC engines is believed to be primarily a function of the intended use and field of application, which typically determine the required power and torque output. Power and torque output are influenced by the power-rotor diameter, the power-rotor depth, the number of vanes on the power rotor, as well as the achievable mass air flow rates through the engine. The use of a rotary power-extraction assembly is believed to result in reduced engine size relative to conventional reciprocating piston engines by providing improved power extraction characteristics. Improved power extraction characteristics are believed to result from the substantially constant moment arm provided, as opposed to the varying moment arm inherent in conventional reciprocating piston engines.

The resulting weight of the presently disclosed rotary IC engines is believed to be influenced by many design parameters. Material choice can have an especially significant influence. Cast iron has been widely used historically for IC engines for three primary reasons—cost, wear properties, and strength at operating temperature. Recently, aluminum has become more widely used in automobile engines for weight reduction. However, industrial engines still tend to be based on steel. Material choice with regard to the presently disclosed rotary IC engines can also be highly influenced by the target application for the engine. In automobiles and aircraft, where weight is a primary consideration, more aluminum can be used. In stationary engines, heavy equipment, and marine use, where weight is not a variable of primary importance, cast iron and steel remain viable choices.

A few specific components of above described embodiments of the presently disclosed rotary IC engines have operating environments that are believed to favor the use of particular materials and finishes, independent of the target application of the engine. These components include: the rotating combustion chamber, the piston valve, the main power rotor, and the vanes. Accordingly, some presently preferred design parameter choices with regard to these components is discussed in more detail below.

The rotating combustion chamber is believed to be subject to both high pressures (estimated to be roughly 2,500 psi), and high temperatures (estimated to approach 2,000 F). The rotating combustion chamber is also believed to required sufficient wear properties so as to provide a reliable sealing surface for the adjacent pressure seals, which can bear against the rotating combustion chamber without lubrication. Accordingly, it is believed that the rotating combustion chamber should be made from a material with relatively high strength at high temperature, as well as sufficient wear properties. It is believed that nickel alloy 718 can be used for the rotating combustion chamber. In order to enhance the wear properties of the rotating combustion chamber, it is believed that a class of ceramic coatings referred to as ‘diamond-like carbon’ (DLC) can be used on the outer surface of the rotating combustion chamber, at least where it interfaces with the pressure seals. A DLC offers very high wear resistance and low friction at high temperatures.

The piston valve, which is used in the above described embodiment to isolate the rotating combustion chamber from the rotary power-extraction assembly prior to combustion initiation, can be subjected to high pressures, high temperatures, and movement under load. It is believed that the piston valve can be made from a stainless steel, although nickel alloy 718 can be used for a more durable design. It is believed that the outer surface of the piston valve can be coated with a DLC ceramic coating to minimize wear on the essentially non-lubricated surface.

The power rotor and vanes are believed to require moderate strength at relatively high operating temperatures. It is believed that the main rotor and vanes can be machined from 4140 steel. Alternatively, it is believed that titanium could offer a better material solution for these components, with the higher material cost being offset by the use of investment castings to obtain near net-shape parts. It is believed that these same materials can be used for the sealing rotors as well.

Although various engine component configurations can be used and still be within the scope of the present invention, it is believed that certain configurations may be preferable for certain engine components in certain applications. These engine components include: the compressor assembly, the rotating combustion chamber, the combustion assembly exhaust piston valve, and the power and sealing rotors.

Although not required, it is currently preferred that the compressor assembly be configured to meet the following two objectives: 1) provide an adequate flow rate of air so as to not limit the overall power potential of the engine, and (2) be able to compress the air to a high enough pressure to achieve compression ignition. The above described embodiment uses a standard reciprocating piston and poppet valve as a means of compressing air. Although both airflow and RPM limitations in a reciprocating piston compressor design may not allow the engine to reach its maximum possible power potential, a primary advantage in a reciprocating piston compressor is the ability to achieve relatively high compression ratios. This is because the moment arm of the offset crankshaft requires successively less torque to be applied as the piston approaches the top of the stroke. For this reason, the offset crankshaft and reciprocating piston arrangement are preferred for a compression ignition engine, particularly when compactness is required in the design. In very large industrial engines and stationary power plant engines, an optimum compressor solution might be to use a rotary vane or rotary screw compressor to charge a compressed air reservoir. From this reservoir, a high pressure manifold would deliver an essentially constant supply of compressed air to the inlet port of the combustion chamber, with the combustion chamber inlet port providing the necessary sequencing of the intake air, very similar in operation to the popular common-rail style of diesel injection systems. This arrangement would enable the rotary expansion chambers to be stacked sequentially without the intermediate pistons, and may provide for high power output.

It is believed that the optimum configuration of the combustion assembly may depend upon the application for the engine. The rotating combustion chamber used in the above described embodiment has seals at each end and at the air inlet port. These seals will be subject to high temperature and wear. The decision to use of a rotating combustion chamber in the above described embodiment was strongly influenced by the space constraints with a small engine. It is believed that in a larger engine design, a more optimum arrangement would likely be to use a fixed cavity as a combustion chamber, and a piston-style valve as the means of sequencing the intake air. The combustion chamber would thus have piston valves at both the inlet and outlet ports, which could be either mechanically driven or electronically actuated. Again, the optimum design solution would be dictated to some degree by the intended use of the engine.

The single cam-driven piston valve used in combustion assembly of the above described embodiment is currently preferred, primarily for simplicity. Favorable features of the piston valve include: a) a large bearing area to pressure area ratio; and b) an actuation force direction that is normal to the pressure force direction, which allows the actuation force to be less than the pressure force as long as the coefficient of friction is less than one (which it typically is).

The single cam-driven poppet valve used as the intake valve in the compressor assembly of the above described embodiment is also currently preferred, primarily for simplicity. Favorable features of the poppet valve include: a) the ability to produce a closed compression chamber in a way that results in very little waste volume (i.e. the valve conforms to the surface of the compression chamber), and b) the ability to withstand very high pressures in the sealing direction. A multiplicity of valves can also be used to enable greater airflow.

It is believed that the power rotor should be designed to achieve a balance of forces about the rotational axis. The power rotor in the above described embodiment uses two vanes to achieve this balance, although balanced forces could be achieved with 3 or more vanes as well. The main drawback to a higher number of vanes is that the rotational speeds of the sealing rotors must increase by the same ratio as the number of vanes. Thus, increasing the number of vanes over the minimum needed to achieve balanced forces (two) can be more practical or advantageous for large engines, which may have lower operating speed requirements.

The sealing rotor in the above described embodiment is machined from a solid cylinder, with lightening holes drilled through the thickness. Another possible sealing rotor configuration can include a cast or extruded outer profile, with a welded central hub and web. The overall mass of the sealing rotor could be significantly reduced in this manner, which would lower the inertial forces on the gear drive mechanism.

It is believed that a range of power rotor diameters can be used for a given engine size. The substantially constant moment arm in the presently disclosed rotary IC engines is a fundamental advantage over a reciprocating piston engine. As rotor diameter increases, the vanes must travel at a higher velocity for a given RPM. The physical limitations of fluid flow (i.e. the speed at which the combustion gas can travel) can provide an upper bound on the maximum achievable rotor diameter and operating RPM. Fortunately, most large engines also operate at relatively low RPM.

It is understood that the examples and embodiments described herein are for illustrative purposes and that various modifications or changes in light thereof will be suggested to persons skilled in the art and are to be included within the spirit and purview of this application. Numerous different combinations are possible, and such combinations are considered to be part of the present invention.

1. A rotary internal combustion engine, comprising:
a compressor assembly;
a combustion assembly coupled with the compressor assembly so as to receive a compressed charge from the compressor assembly, the engine adapted to provide isolation between the compressor assembly and the received compressed charge, the combustion assembly adapted to initiate combustion after the isolation of the compressed charge and discharge expansion gases; and
a rotary power-extraction assembly coupled with the combustion assembly so as to receive expansion gases discharged by the combustion assembly, the rotary power-extraction assembly comprising:
a housing, the housing including a cavity, and
a power rotor rotationally disposed within the cavity and adapted to extract power from the received expansion gases.

2. The engine of claim 1, wherein the combustion assembly includes a rotating combustion chamber adapted to receive a compressed charge during a first rotation of the combustion chamber and provide isolation between the compressor assembly and the received compressed charge during a second rotation of the combustion chamber.

3. The engine of claim 2, wherein the rotating combustion chamber is mechanically coupled with the compressor assembly.

4. The engine of claim 1, wherein the combustion assembly includes a combustion chamber, and wherein the engine is further adapted to provide isolation between the combustion chamber and the rotating power-extraction assembly prior to combustion initiation.

5. The engine of claim 4, further comprising a piston valve adapted to provide isolation between the combustion chamber and the rotating power-extraction assembly prior to combustion initiation.

6. The engine of claim 1, wherein the compressor assembly includes a crankshaft coupled with a reciprocating piston.

7. The engine of claim 6, wherein the compressor assembly includes two or more crankshafts, each crankshaft being coupled with at least one reciprocating piston.

8. The engine of claim 1, wherein the compressor assembly is mechanically coupled with the rotary power-extraction assembly so as to transfer power from the rotary power-extraction assembly to the compressor assembly.

9. The engine of claim 1, wherein the combustion assembly includes a combustion chamber, and the engine is further adapted to provide isolation between the combustion chamber and the rotating power-extraction assembly prior to combustion initiation.

10. A rotary internal combustion engine, comprising:
a compressor assembly;
a combustion assembly coupled with the compressor assembly so as to receive a compressed charge from the compressor assembly; the combustion assembly adapted to discharge expansion gases; and
a rotary power-extraction assembly coupled with the combustion assembly so as to receive expansion gases discharged by the combustion assembly, the rotary power-extraction assembly adapted to extract power from the received expansion gases, the rotary power-extraction assembly including:
a housing including:
a first cavity disposed within the housing and substantially defined by axial-symmetric walls; and
a second cavity disposed within the housing and substantially defined by axial-symmetric walls, the second cavity intersecting the first cavity;
a power rotor rotationally disposed within the first cavity, the power rotor and the housing defining an annular chamber therebetween, the power rotor including a vane extending from the power rotor into the annular chamber;
a sealing rotor rotationally disposed within the second cavity, the sealing rotor including a recess sized to accommodate the vane during a rotation of the power rotor;
an inlet coupled with the combustion assembly and the annular chamber for the transfer of expansion gases from the combustion assembly to the annular chamber; and
an outlet coupled with the annular chamber for the discharge of expansion gases from the annular chamber.

11. The engine of claim 10, wherein:
the power rotor further includes a second vane extending from the power rotor into the annular chamber;
the housing further includes a third cavity disposed within the housing and substantially defined by axial-symmetric walls, the third cavity intersecting the first cavity; and
the rotary power-extraction assembly further includes a second sealing rotor rotationally disposed within the third cavity, the second sealing rotor including a recess sized to accommodate the vanes during a rotation of the power rotor.

12. The engine of claim 10, wherein the combustion assembly is further adapted to initiate combustion, and the engine is adapted provide isolation between the compressor assembly and expansion gases.

13. The engine of claim 10, wherein the combustion assembly includes a rotating combustion chamber adapted to receive a compressed charge during a first rotation of the combustion chamber and to provide isolation between the compressor assembly and the received compressed charge during a second rotation of the combustion chamber.

14. The engine of claim 13, wherein the engine is further adapted to provide isolation between the rotating combustion chamber and the rotating power-extraction assembly prior to combustion initiation.

15. The engine of claim 10, wherein the compressor assembly includes a crankshaft coupled with a reciprocating piston.

16. The engine of claim 15, wherein the compressor assembly includes two or more crankshafts, each crankshaft being coupled with at least one reciprocating piston.

17. The engine of claim 12, wherein the combustion assembly includes a combustion chamber, and the engine is further adapted to provide isolation between the combustion chamber and the rotating power-extraction assembly prior to combustion initiation.

18. The engine of claim 10, wherein the combustion assembly includes a combustion chamber, and the engine is further adapted to provide isolation between the combustion chamber and the rotating power-extraction assembly prior to combustion initiation.

19. A method of manufacturing a rotary internal combustion engine, comprising:
providing a compressor assembly;
coupling a combustion assembly with the compressor assembly so as to receive a compressed charge from the compressor assembly, the engine adapted to provide isolation between the compressor assembly and the received compressed charge, the combustion assembly adapted to initiate combustion after the isolation of the compressed charge and discharge expansion gases; and
coupling a rotary power-extraction assembly with the combustion assembly so as to receive expansion gases discharged by the combustion assembly, the rotary power-extraction assembly including:
a housing, the housing including a cavity, and
a power rotor rotationally disposed within the cavity and adapted to extract power from the received expansion gases.

20. A method of manufacturing a rotary internal combustion engine, comprising:
providing a compressor assembly;
coupling a combustion assembly with the compressor assembly so as to receive a compressed charge from the compressor assembly; the combustion assembly adapted to discharge expansion gases; and
coupling a rotary power-extraction assembly with the combustion assembly so as to receive expansion gases discharged by the combustion assembly, the rotary power-extraction assembly adapted to extract power from the received expansion gases, the rotary power-extraction assembly including:
a housing including:
a first cavity disposed within the housing and substantially defined by axial-symmetric walls; and
a second cavity disposed within the housing and substantially defined by axial-symmetric walls, the second cavity intersecting the first cavity;
a power rotor rotationally disposed within the first cavity, the power rotor and the housing defining an annular chamber therebetween, the power rotor including a vane extending from the power rotor into the annular chamber;
a sealing rotor rotationally disposed within the second cavity, the sealing rotor including a recess sized to accommodate the vane during a rotation of the power rotor;
an inlet coupled with the combustion assembly and the annular chamber for the transfer of expansion gases from the combustion assembly to the annular chamber; and
an outlet coupled with the annular chamber for the discharge of expansion gases from the annular chamber.
